(19) United States
(12) Patent Application Publication
(10) Pub. No.: US 2010/0241962 A1
(43) Pub. Date: Sep. 23, 2010

(54) MULTIPLE CONTENT DELIVERY ENVIRONMENT

(76) Inventors: Troy A. Peterson, Stillwater, MN (US); Terrance Clifford Schubring, Saint Paul, MN (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/684,102

(22) Filed: Jan. 7, 2010

Related U.S. Application Data
(60) Provisional application No. 61/162,671, filed on Mar. 23, 2009.

(51) Int. Cl. G06F 3/01

(52) U.S. Cl. 715/720; 715/719

(57) ABSTRACT

A content presentation environment enables a primary content source to be presented to a user, along with supplemental content that may relate to the primary content or, may be completely unrelated (such as an advertisement). As the primary content is presented, supplemental content is either automatically presented or made available for selection by a user. In addition, a user may select and add additional supplemental content to be associated with or incorporated into the presentation environment.

### CROSS-REFERENCE TO RELATED APPLICATIONS

This is a United States Non-Provisional Application for patent being filed under 35 USC 111 and claiming the benefit of the filing date of United States Provisional Application for patent that was filed on Mar. 23, 2009 and assigned Ser. No. 61/162,671, which application is hereby incorporated by reference.

This application is related to the United States Non-provisional patent application bearing the title of CONTENT PRESENTATION CONTROL AND PROGRESSION INDICATOR, filed concurrently herewith and identified by attorney docket number 14018.1020, which application is hereby incorporated by reference.

### BACKGROUND

During the world's migration to an Internet and connected world, many trials and errors were realized in trying to identify, define, implement and sell the most applicable, usable and intuitive user interfaces. The natural tendency is to try to recreate in an online connected environment, a duplicate of the real world environment. As a result, we end up with user interfaces that include a desktop, folders and files. You may have seen other attempts, such as the book reader that actually looks like a book, allowing you to turn pages just as though you were reading the physical book. However, as the Internet and computer sophistication level of the typical target user increases, newer and more innovative user interfaces have emerged. Certainly, in some cases, the familiarity of the physical and real world are and should be incorporated into the user interfaces but, such user interfaces should not neglect the powerful, ergonomic, intuitive and content rich features that can be woven into such interfaces by exploiting, relying upon and making use of the relative environment to enhance these user interfaces. For instance, one cannot ignore the fact that the user interface to a computer, network or global network is built off of keyboards, pointing devices, touch sensitive screens, video displays, audio systems and even voice activated commands.

The gaming world has taken all of these elements a few steps forward by the inclusion of man to machine interface elements such as motions detectors built off of a variety of technology platforms including gyros, accelerometers, optical sensors, etc.

However, another entire world of user interface enhancement can be realized when one focuses on what is available for the user's disposal within the network cloud. While viewing an item on the screen, the user interface can be probing, crawling or digging through the network cloud to find information relevant to what the user is presently doing, viewing or interacting with through the computing platform.

As the technology associated with the Internet and computers in general continues to improve by becoming faster, more robust, more efficient and more able to deliver larger amounts of information, the user interfaces must also evolve to provide cleaner, intuitive delivery of such information. Thus, there is and continues to be a need in the art for user interfaces, and especially user interfaces that deliver information, to be improved and to track with the current technological capabilities.

### SUMMARY

In general, the present disclosure is directed towards a media delivery and interactive environment, referred to herein as the media environment, which provides a synchronized or timeline-oriented content delivery system that can be based on multiple media types and can be modified or enhanced on the fly by viewers or users of the content. An exemplary embodiment provided as a non-limiting illustration may include primary content, such as video content, to be rendered or played back, while a series of supplemental content items, such as web-pages, blogs, web articles, articles, documents, WIKIPEDIA pages, etc., are rendered at various times during the playback. The media delivery and interactive environment may be implemented or provided as a system or a method, or may even be implemented within or provided as an apparatus.

In one embodiment, the media delivery environment presents primary content and supplemental content in a time-line related scheme by a computing device having access to at least the source of the primary content and/or the supplemental content. It should also be appreciated that rather than a time-line related scheme, other relationship schemes may be employed in lieu of or in addition to the time-line related scheme. For example, the primary and supplemental content may be related based on space, position within a file or stream, subject matter, key-words, user interaction (such as book marking or highlighting portions of the primary content), etc.

In operation, this embodiment operates to receive a selection indicator from a client device to invoke the playback or request rendering of a particular primary content item. In response, the primary content is then rendered on a user interface of the client device. While the primary content is being rendered, the media delivery environment identifies a supplemental content item that is associated with a particular portion of the primary content item in some manner, or in some instances, the supplemental content can be selected at random such as advertisements, etc. At an appropriate time, the supplemental content is rendered on the user interface device of the client device. The rendering of the supplemental content can be automatic (i.e., based on the timeline, may be initiated in response to a user actuation, or any of a variety of other criteria. In one embodiment, the supplemental content is rendered proximate to the ongoing primary content item so that the content can be viewed side by side.

More particularly, in one embodiment the media delivery system may operate to provide video content, such as a YOUTUBE video as the primary content in which the video is rendered on a display device and the audio is presented at a speaker. In such an embodiment, the supplemental content items may be associated with a particular point in time, or offset from the beginning of the video content. The supplemental and primary content can be presented or rendered in a variety of formats or manners. In one embodiment, a progressive timeline bar associated with the video file is displayed. A thumbnail representative of the supplemental content is rendered or displayed on or proximate to the location on the progressive timeline bar to which it corresponds in time to the video content. As the playback of the video file approaches the particular point in time at which the thumbnail sketch is displayed, the supplemental content is activated.

Activating the supplemental content may include visibly modifying the thumbnail representing the supplemental content. For instance, the size of the thumbnail may be changed to emphasize or deemphasize it, the thumbnail can be presented in a Fibonacci spiral, or a variety of other techniques may be used in lieu of or in addition to any of these techniques.

While a particular supplemental content item is active, embodiments may operate to automatically render the supplemental content or require a user actuation or some other event. For instance, in one embodiment an actuation of or pertaining to the supplemental content is received. In response to this actuation, the supplemental content, such as text, graphics, audio, video or a combination thereof as well as other content, is retrieved. The supplemental content may be retrieved from local storage or from remote storage such as over a network or the Internet. In addition, the supplemental content may be created on the fly or may be dynamic data such as weather, stock information, sporting scores, or simply updated data the is retrieved at the time of viewing to maintain relevance.

In another embodiment, the media delivery environment operates to present primary content along with a series of supplemental content items. Initially, a selection indicator is received invoke a particular primary content item. As the primary content item is rendered or as a part of the invocation process, supplemental content items associated with the various portions of the primary content are identified. As the supplemental content items become active, they are either rendered or a user can cause them to be rendered. As a non-limiting example of a user interface for rendering the content, a timeline associated with the video content is displayed. A graphic element is then displayed on the timeline for each supplemental content item in such a manner that is representative of the point in time that the supplemental content item would become active. The timeline may also include a cursor to show the progression through the video content. As the cursor approaches a supplemental content item, the graphic may be enhanced to show that the supplemental content is relevant and that it can be selected for rendering. As the cursor arrives at the supplemental content item, the content could be immediately rendered or the user can request rendering. As the cursor passes the supplemental content item graphic, the graphic is then deemphasized.

These and other embodiments and configurations are presented in more detail along with the drawings and the description associated therewith.

### BRIEF DESCRIPTION OF THE SEVERAL VIEWS OF THE DRAWING

FIG. 1 is a screen shot of an exemplary layout for a synchronized content delivery system.

FIG. 2 is a close-up view of the content-timeline of FIG. 1.

FIG. 3A-3E is a series of portions of screen shots illustrating one implementation for presenting the nibs to a user interacting with a nibi.

FIG. 4A-FIG. 4D presents an alternate embodiment for presenting the nibs in the active window of a nibi display screen.

FIG. 5 is a screen shot of another exemplary layout for a synchronized content delivery system.

FIG. 6 is a flow diagram illustrating the high-level steps on an exemplary embodiment of the synchronized media system.

FIG. 7 is a general block diagram illustrating a hardware/system environment suitable for various embodiments of the synchronized delivery system.

FIG. 8A is a schematic depiction of an alternate programming embodiment.

FIG. 8B is a table diagram of an alternate programming embodiment.

### DETAILED DESCRIPTION OF EMBODIMENTS OF THE INVENTION

The present disclosure is directed towards a media delivery and interactive environment, referred to herein as the media environment, which provides a synchronized or timeline-oriented content delivery system that can be based on multiple media types and can be modified or enhanced on the fly by viewers or users of the content.

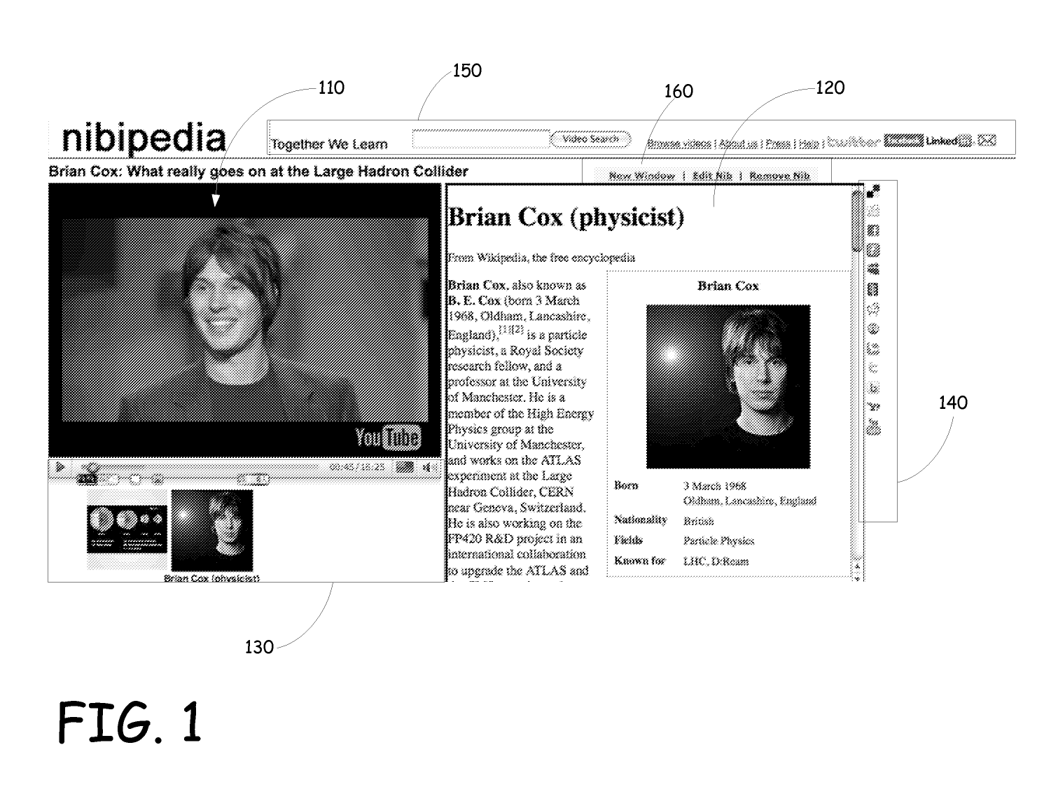

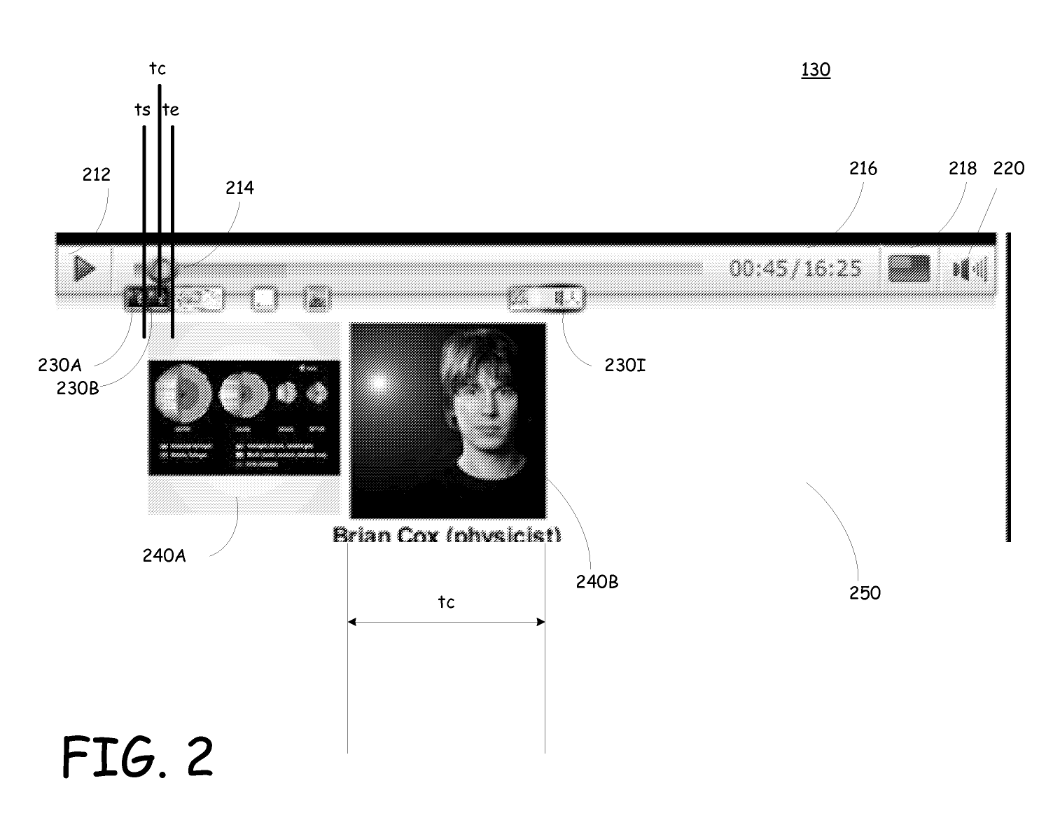

FIG. 1 is a screen shot of an exemplary layout for a media environment providing a content delivery system. The layout depicts a user interface, or the content rendering format, to enable a user to view time-line oriented content from one or more sources. The depicted screen shot 100 include three content areas, as well as additional features. The three content areas include the primary content display area 110, the supplemental content area 120 and the content-timeline 130. In the illustrated embodiment, the primary content area 110 is shown as rendering a YOUTUBE video. The supplemental content area 120 is shown as rendering textual and graphical information or content about the speaker shown in the primary content area 110. The content-timeline 130 renders thumbnails, or other tags, avatars or other content identifiers (referred to collectively as thumbnails) in a timeline like fashion. Further details to the content-timeline 130 will be provided in conjunction with the description of FIG. 2.

In the illustrated embodiment of the media environment, the two sources of content include a YOUTUBE style video and Wikipedia style information, herein after referred to in general as video content and supplemental content. However, it will be appreciated that the primary content does not necessarily have to be video and the primary and/or supplemental content can be text, graphics, photos, audio, video, slide presentations, flash content, or any of a variety of other content as well as a mixture or combination of two or more different types of content. To facilitate the understanding of the various embodiments, the primary content will generally be described as video content and the supplemental or secondary content will be described as external metadata or Wikipedia data, or the like—generally consisting of text and/or graphics. However, it will be appreciated, and as pointed out in this disclosure, that this is merely one non-limiting example of an embodiment of the media environment and various other source types and embodiments, as well as combinations and hybrids are also anticipated.

Thus, the illustrated media environment presents a video of content that is supplemented by written text and graphics. As such, a user that is experiencing the video playback may also make reference to supplemental content that may be related to the video content, portions of the video content, previously played portions of the video content, upcoming portions of the video content or, in other embodiments, the supplemental content, and yet in other embodiments the supplemental content may include a mix of content that may or may not be related to the video content in general, or specific portions of the video content.

As a non-limiting example, assume that an embodiment is used to present video content of an individual performing a lecture or talk on a specific topic. At the beginning of the lecture, the supplemental information may contain bibliographic information about the speaker as shown in FIG. 1. As the lecture progresses, the supplemental content may change to provide further information about a specific point that is being made by the lecturer, information about a specific person or item that the lecturer is talking about, advertisements about related or totally unrelated products, information about additional content or related content that has just recently become available, information about other activities to which the user may be interested (i.e., a video call is received for the user, an email message has been received, an important lecture is about to begin on a different internet channel, etc.).

FIG. 1 also includes a destination vector array 140, a search engine interface 150 and a content modification interface 160. The illustrated destination vector array 140, which is also referred to as a social share bar in some embodiments, provides one or more graphics that represent destinations to which content can be sent, ported to or made available. The search engine interface 150 enables a user to enter search criteria to find related content, or to browse from available content. Finally, the content modification interface 160 allows a user to add cross-references between primary and supplemental content, edit the actual content, etc.

FIG. 2 is an enlarged view of the content-timeline 130 of FIG. 1. Again, although the illustrated embodiment is shown as a YOUTUBE type video provision for the primary content, other video sources or other types of sources are anticipated for the primary content. A few non-limiting examples of primary content include broadcast programming, cable programming, video, movie media (such as DVDs, BLURAY, etc.), web based content, power point presentations, live video feeds, slide shows, audio content with/without graphics, etc. The illustrated embodiment includes a playback bar 210 that includes a play/pause button 212, a progress or status bar 214, a time played/time remaining or total time display 216, a maximize/minimize/zoom activator 218 and a volume control activator 220. The playback bar is typical of the controls and interfaces required in a typical video playback interface. In addition, FIG. 2 shows multiple tags or graphic icons 230A-I that are presented along the progress or status bar 214. In the illustrated embodiment, the progress or status bar 214 depicts the entire length of the video and as such, the tags 230 are shown over the full play time of the video content. However, in some embodiments only a portion of entire contents may be presented on the progress or status bar 214 and as such, the tags 230 may be scrolled into and out of view as the video or content progresses. In addition, in some embodiments the content tags 230 may be overlapped or compressed to fit them onto the timeline as necessary.

Below the playback bar 210 is a time-line 250 of the tags, enlarged so that the graphics or content are more recognizable. Because the graphics are larger, only a portion of all of the available tags can be displayed. The window 250 shows the tags that are associated with the currently playing segment of the primary content, plus or minus a particular period of time. For instance, in one embodiment, the tag associated with, or most closely associated with (i.e., time-wise) the currently playing primary content is displayed in proximity to the center of the window 250 with additional tags displayed left or right of the center tag. The tags displayed to the left are tags associated with primary content that has already been viewed and the tags to the right are associated with primary content that is soon to be played. In the illustrated embodiment, the progress bar shows that the playback of the primary content is at point t=tc (time current) which lies between ts (time start) and te (time end). The tag 230B which is shown as existing on the progress bar 214 between ts and te is then the current tag and the window 250 is showing a larger version as tag 240B. The window 250 also shows tag 240A, a larger version of tag 230A which was just recently viewed.

In the illustrated embodiment, no additional tags are shown on the right hand side of the current tag 240B; however, in some embodiments the next one or more tags 230C, 230D, etc, may be enlarged and presented in the window 250. The location of tag 240B can be referred to as the current window or the active window for displaying a tag when the current time tc falls between the ts and the te for a tag. As such, it will be appreciated that the size of the tags on the progress bar may be compressed or expanded to cover the applicable space in time on the progress bar 214. In other embodiments, the tag may simply be used to indicate the start of the applicable time space and all the tags can be uniform in size. In such an embodiment, if the applicable time space is less than what would be represented by the width of the tag, then the tags can be overlapped with the beginning of each tag corresponding with the correct ts on the progress bar 214. It should also be appreciated that rather than having miniaturized versions of the tag displayed on the progress bar 214, simply graphics such as dots may be used instead. The use of varying colored dots would allow dots or markers in close proximity to each other to be distinguished.

Looking in more detail at FIG. 1, the operation of various embodiments is described. The applicants have coined the term “nib” which is defined in this disclosure as a visual hyperlink to data, such as external data or external metadata. In the disclosed embodiments, a nib consists of a picture or other content and a link that is positioned at some point along a content timeline, such as a video. In FIG. 2, the tags 230A-230I are nibs.

The phrase “adding a nib” is defined as the act or procedure of adding a nib to a content timeline, such as adding an article annotation to a video timeline. Thus, representing an article annotation, or any supplemental content in association with primary content is a nib. One particularly well suited application for the various embodiments includes educational applications. In such an embodiment, an annotation of an article is part of the metadata associated with a video (or other primary content) for the purposes of cross referencing videos or teaching or communicating using external article data sources.

The applicants have also coined the term “nibi” which is defined in some embodiments as a video wiki but more broadly, the combined and synchronized presentation of a primary content and a secondary content.

In general, the primary content is presented in either a time space or a physical space. For instance, time space presented content could be in the form of live streaming audio or video, recorded audio or video, slide shows, power point presentations or the like. Physical space presented content could be in the form of a web page, a word file, or any other file that typically would be too large to be presented on a single screen but, not necessarily. In physical space content, rather than marking a present position with time (i.e., tc) other mechanisms may be used such as the location of a cursor, the currently displayed page or paragraph, etc.

The supplemental content may likewise be any of a wide variety of content including video, audio, slide shows, graphics, web pages, metadata, status updates from existing social networks such as but not limited to FACEBOOK, LINKED IN, MYSPACE or TWITTER, microblogging applications, blog data, etc.

Thus, it will be appreciated that a nibi can take on a wide variety of forms and applications. A few non-limiting examples of such applications are described following.

Archived synchronous video conversations for later playback. In this exemplary application, two parties engaged in a video conference may share documents, data, files, or the like during the course of the video conference. Each of the items presented may be earmarked to be associated with the particular time in the time space of the video conference at which it was presented. The video conference content, along with the shared supplemental content and the association between the two can then be stored. Subsequently, the video conference can be reviewed by parties and give access to not only the video conference but also all of the supplemental material presented therein. A similar application to this would be in the legal field for taking depositions of parties by videotaping the deposition and adding exhibits utilized during the deposition as nibs.

Searchable video help file. In this exemplary application, the entire manual for an application, such as MICROSOFT WORD may be presented in a window. As the manual is scrolled or searched through, applicable content for the particular portion of the manual being displayed may be presented in an alternate window.

In some embodiments, the nibi files may simply be played back. However, in other embodiments the ability to create or modify nibis may be provided. For instance, as a user reviews a document, a video or the like, the user may identify annotations or supplemental content to be associated with the video and at particular points in time. The user interface may allow the user to select the point in time (or space in some embodiments) at which to associate the supplemental content, and then identify the content. At this point the content is then linked to the particular location in the primary content and will then be retrievable in the future. For instance, a content item can be dragged and drop onto the timeline or, a programmable timeline or schedule can be presented as an interface for building nibis, as well as other interfaces. Thus, the actions of dragging, earmarking, or otherwise identifying particular content to be associated with a primary content source is the process of creating a nibi.

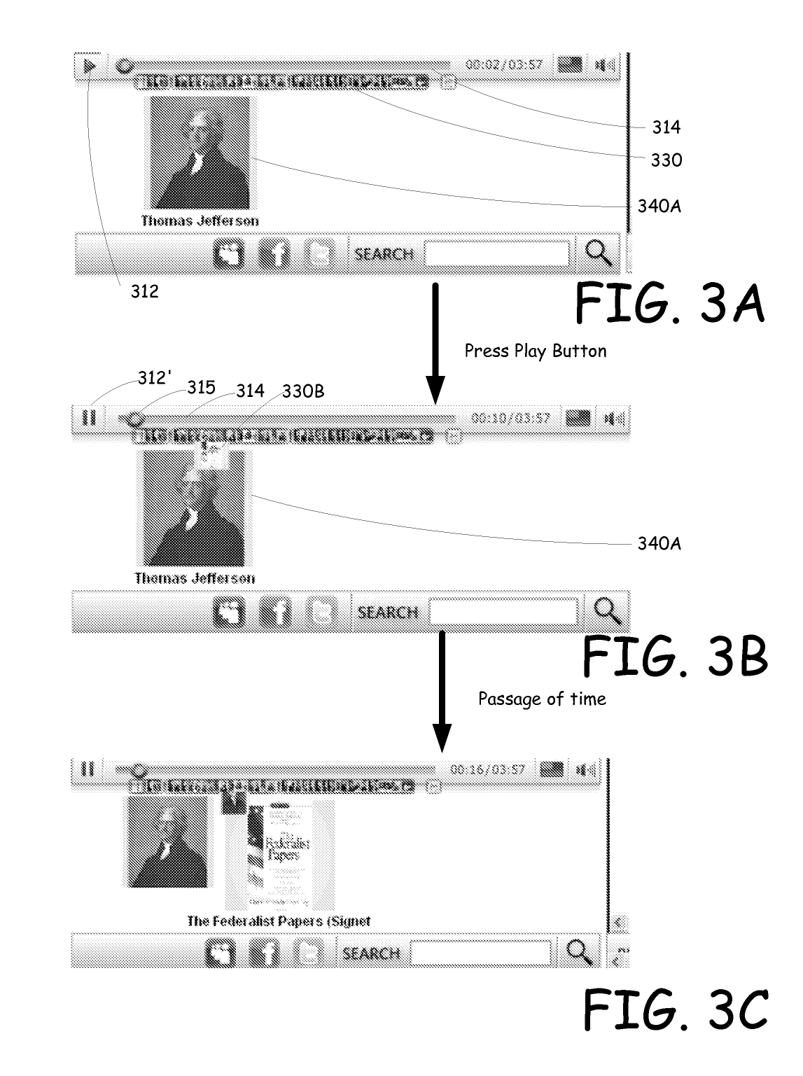

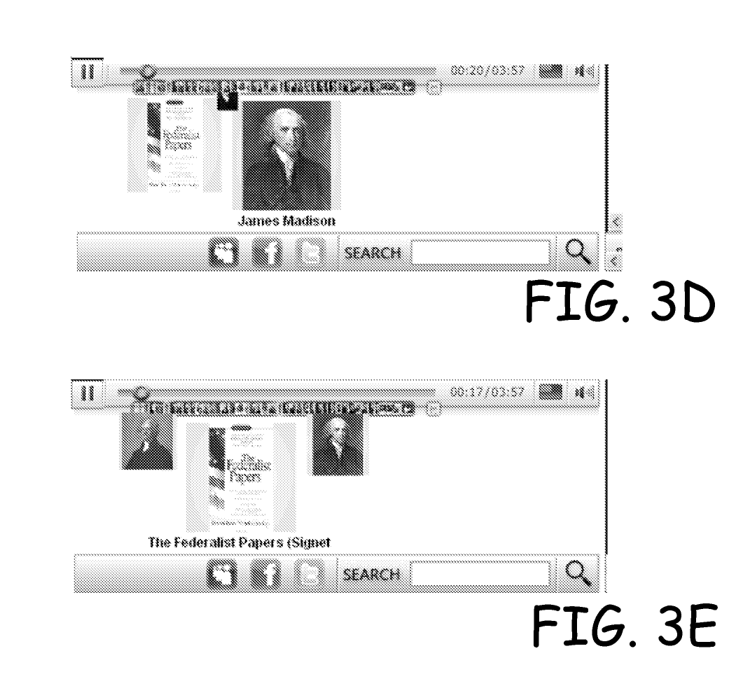

FIG. 3A-3E is a series of portions of screen shots illustrating one implementation for presenting the nibs to a user interacting with a nibi. The nibs are shown in the screen of FIG. 3A as being associated with the progress bar 314. The presentation of the primary content (which is not shown in this illustration) is presently paused as indicated by the play button being presented 312. In the presented state, the primary content is ready for presentment but the presentment has not yet begun. The currently active nib 340A is displayed in the window. Once the play button 312 is activated, the play button changes to a pause button 312′ and the presentation of the primary and supplemental content commences FIG. 3B. As the presentation continues, the time cursor 315 begins to advance across the progress bar 314. As the time cursor 315 approaches the next time point that includes an associated nib (i.e., nib 330B), the nib begins to expand from its position on the time line along with the other nibs 330, and moves down into a position proximate to nib 340A. As the new nib grows and moves into position 340B, the previous nib 340A begins to shrink and move back to its position 330A on the timeline. Furthermore, if another nib is being approached, it begins to likewise expand and move down into position as depicted in screens of FIG. 3C, FIG. 3D and FIG. 3E.

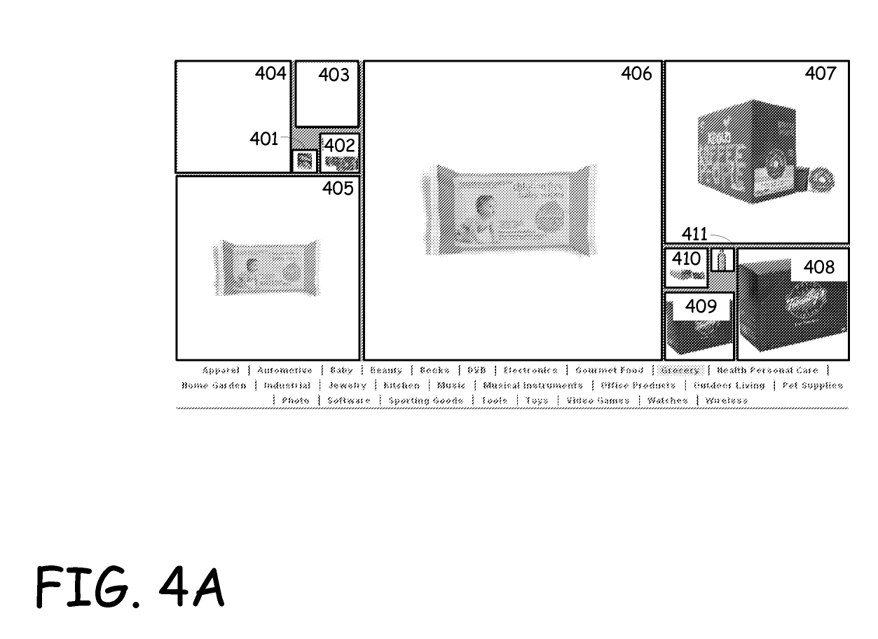

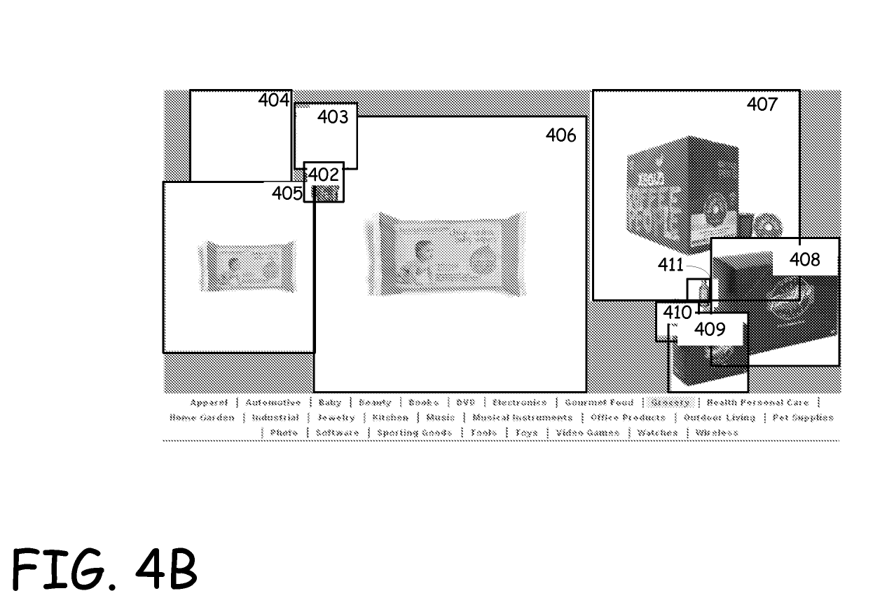

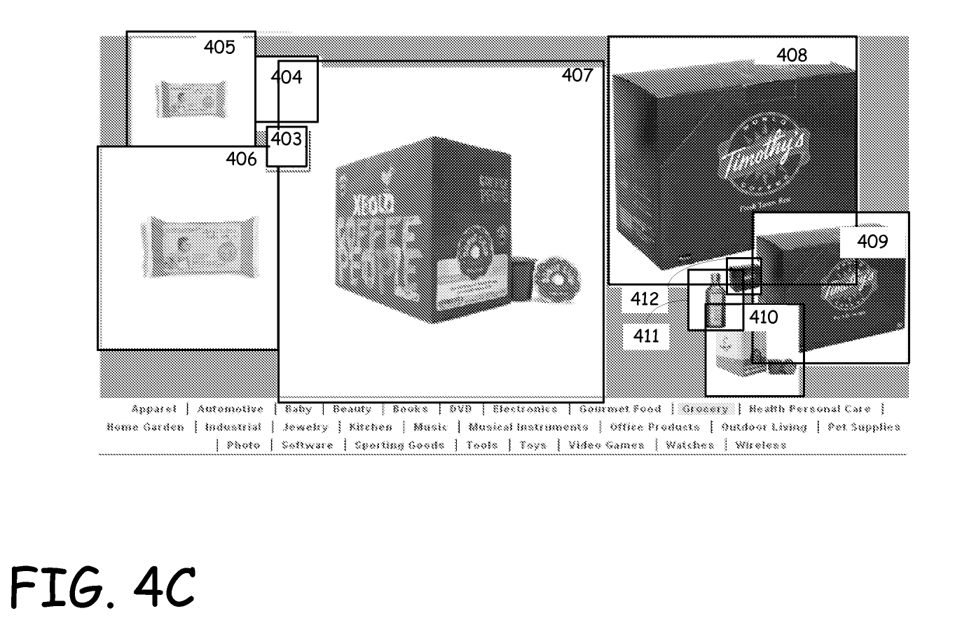

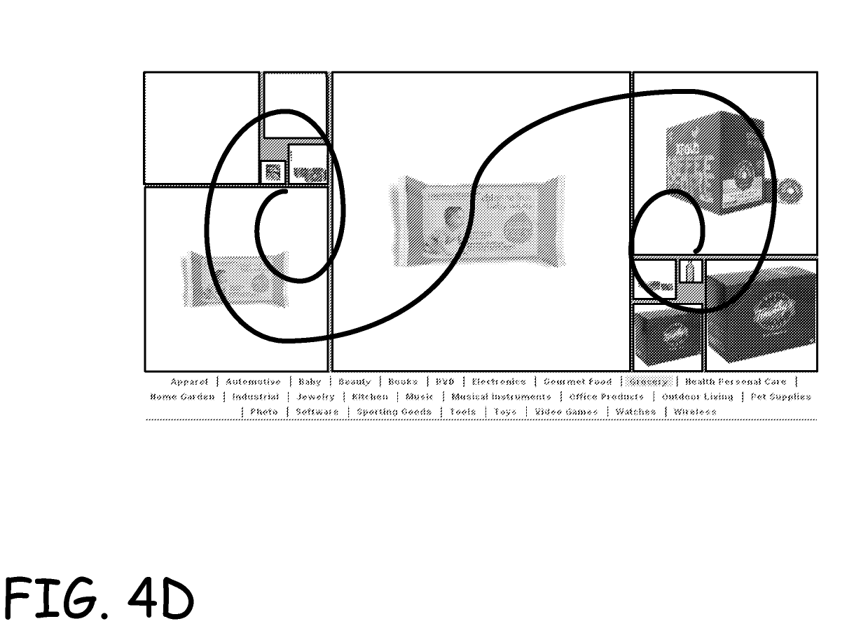

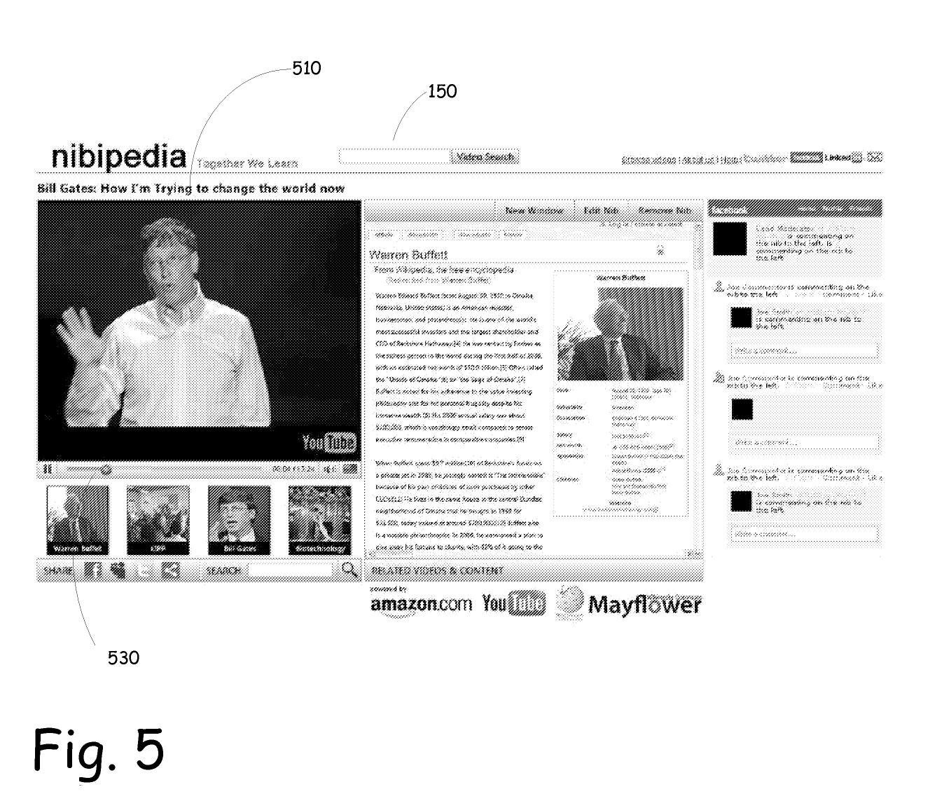

FIG. 4A-FIG. 4D presents an alternate embodiment for presenting the nibs in the active window of a nibi display screen. In the illustrated embodiment, referred to as the spiral flow embodiment, 11 nibs 401-411 are shown as being presented in a steady state with the active or current nib 406 being located in the middle of the window. It will be appreciated that in the various nibi embodiments, additional information about the nib 406 may be presented in a different window or screen whereas in other embodiments, the nib may be large enough to suffice. When time passes, the displayed nibs 401-411 move in a spiral fashion with the nibs on the right spinning up to be larger while the nibs on the left spin down and eventual disappear. For instance, FIG. 4B shows the movement of the nibs 401-411 as some time passes. Nib 401 has already spiraled off of the window. In FIG. 4C, a new nib 412 has emerged into the display. FIG. 4D illustrates a path that the nibs follow in this exemplary embodiment. The spiral flow is a list viewer that is a means of displaying image, article or other data in a Fibonacci spiral that allows a user to view an infinite number of results in the most efficient way possible in two dimensions. While the nibs are spiraling through, a user can select one of the nibs. The selected nib will immediately spiral forward or backwards to the active position. In some embodiments, the spiral may then pause for a particular period of time before commencing to spiral again. In other embodiments the spiral may be suspended until the user activates the spiral again. In some embodiments, the user may scroll through the various items in the list by activating a scroll bar or dragging the times on one end of the spiral to the other side. The list in the spiral may be finite or infinite. In addition the list may be dynamically updated by new items being added in real-time.

It should also be appreciated that in addition to moving and modifying the size of the thumbnails or nibs, other effects to accentuate or highlight the nibs may also be used. For instance, as a nib approaches its center stage state or active state, the nib may move from being fuzzy, out of focus, transparent, etc. into a crisp, focused, non-transparent state. Similarly, non-active nibs may be displayed in black and white while an active nib may be displayed in color. Or, as nibs move from towards an active state, the nibs may be modified from black and white towards color. Thus, it will be appreciated that these, as well as any of a variety of other effects, or combinations thereof may be used to show the progression of a nib to the active state and then back again.

FIG. 5 is a screen shot of another exemplary layout for a synchronized content delivery system. This embodiment is shown as being incorporated into a FACEBOOK environment. The simplified implementation includes the three content areas: the primary content display area 510, the supplemental content area 520 and the content-timeline 530. However, the content-timeline 530 is simplified from the embodiment illustrated in FIG. 1 by removing the nibs from being positioned along the progress bar. Another illustrated feather that may be incorporated into various embodiments includes the link(s) to related videos and content. In some embodiments, the nibs along a timeline provide this feature, however, in some embodiments a separate tool tray can be provided to contain related content and/or videos that either relate back to the primary content or that relate to the supplemental content. In this latter embodiment, as supplemental content is rendered, the related items tray or selection availability may change accordingly.

An exemplary operational flow of various embodiments may include the following steps. Initially, a nibi to be presented or viewed is selected. Once the nibi is loaded, the user may activate the play button or, the nibi may automatically commence playing upon being loaded. In the illustrated embodiments in the which the primary content is a video and the supplemental content is metadata, when the nibi starts to play the video content in the primary display area begins to play. The nibs are then moved from inactive to active or current positions based on the time location within the video playback. When a nib is active, more detailed content is then presented in the supplemental content area.

In the various embodiments, as a nibi is being presented, the nibs move from being inactive, to active and then back to inactive. If the user drags the time cursor on the progress bar, the nibs will be scrolled through in accordance with their association on the timeline. In addition, if a user selects an inactive nib, the presentation of the primary content can immediate scan forward or backward to the time slot or location that is associated with the selected nib. As the nibs become active, the data associated with the nib is then displayed in the supplemental content area.

It should be appreciated that although the two content sources are described as primary and supplemental, these terms may not have any weight with regards to the importance or main focus of the content. For instance, in one embodiment, the supplemental content may actually be the driving or the main focus of the content presentation. As a non-limiting example of such an embodiment, the nibs may include various pages of a text book or handout for a collegiate level course being offered online. As the viewer selects a particular page in the text, the video content may fast forward or rewind to a portion of a lecture that is associated with that page. Thus, in such an embodiment the text operates as the primary focus of the presentation with the video content providing additional information to support the text.

Returning to FIG. 1, attention is drawn to the destination vector array 140 or, in the illustrated example, the social share bar. This feature that can be incorporated into various embodiments includes the ability to provide drag and drop deep linking. This feature allows a user to select a nib, either active or inactive, and drag it to an icon located on the social share bar 140. The icons on the social share bar 140 may be any of a wide array of destinations such as FACEBOOK, TWITTER, an email outbox, a user's blog, an RSS feed, etc. When the nib is dragged and dropped, a link to the annotation or article (supplemental content), along with the time reference in the video content (primary content) is provided as input to the destination application. As a result, the recipient of the link can review the annotation and simultaneously start the video at that relative point in time.

As previously mentioned, the various embodiments have been described as having the primary content as a video and the supplemental content as metadata. However, it will be appreciated that other embodiments may also incorporate the various features disclosed. For instance, the various features could be used for displaying footnotes or references in a document or article as the article is scrolled through. The various footnotes or references may be presented at nibs along the scroll bar and when a passage that is associated with a footnote or reference is being viewed in the primary content area, the footnote or reference may be displayed in the supplemental content area. In another embodiment, the primary display area may be a browser window for a web page. As the user scrolls the cursor over various links on the web page, the supplemental content area may display the rendered results of associated URLs on the main web page.

In one embodiment, the various features, or subsets thereof may be provided in a software program that can be used to present a users content, link supplemental and primary content together, etc. For instance, the user may be enabled to create socially-annotated video help files on any topic. The software environment allows users to share information with one another using the most widely adopted tools on the Web. The various embodiments are applicable to a wide range of applications, and particularly well suited for the markets of e-learning and customer service.

The nibis, or video Wikis allow users to collaborate and discover and share information real time with one another. These transactions can then be stored and reused driving down customer service costs or increasing the scalability of educational environments. As such, content such as classroom lectures, conference calls, video conference calls, SKYPE calls, GOTOMEETING sessions, etc. can easily be recorded and viewed at a later time in a later place.

One advantage of some embodiments is that the software program can be powered by free services from sites such as YouTube, Wikipedia, Amazon and Facebook. Customization options include branding or integration with other social and database environments such as Myspace, Twitter, custom wiki's, peer reviewed journals, Educational or Marketing Content Management systems or product databases. Nibi's allow for simplified sharing of articles or links within a group of students or customers.

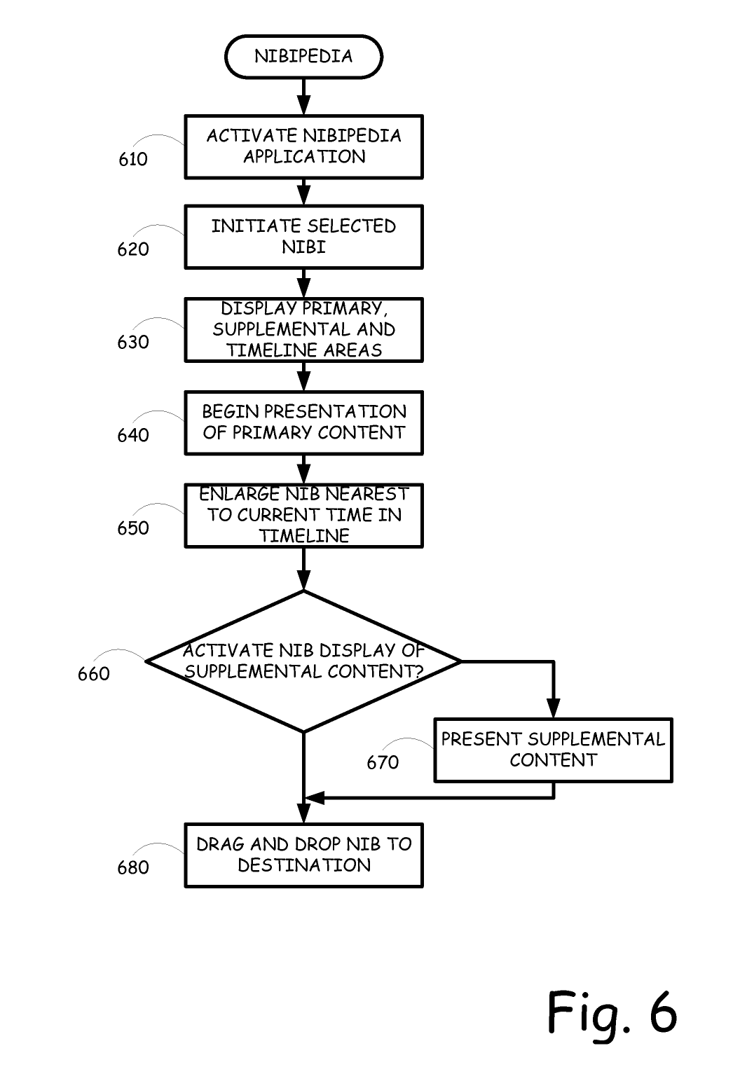

The following is a simplified explanation of how a user interacts with a nibi. FIG. 6 is a flow diagram illustrating the high-level steps on an exemplary embodiment of the synchronized media system. From the homepage, such as nibipedia.com or after activating a nibipedia program either as a web application or even a local application 610, a user is presented with a home screen from which the user can select a recent video, popular videos or search for something interesting. Once the user identifies a selected video or primary content, the presentation of the nibi is initiated 620. The primary, supplemental and content timeline areas are then displayed 630. Below the video timeline small images are displayed (i.e. FIG. 1 and FIG. 2). These small images are nibs. As previously described, a nib is a visual annotation that links to resources such as wikipedia articles, books, music, other videos or DVDs, etc. The primary content is then presented and as the timeline progresses 640, the nearest nib is enlarged, highlighted or in some other way accented 650. If the user clicks on the nib 660, the user can then view the resource or article in another window, frame or area, such as on the right hand side as illustrated in FIG. 1—the supplemental content area 670. In some embodiments, below the article there is a list of videos related to that article. To share a nib or nibi with your others, the nib can be dragged onto one of the social share icons 680. When the other party selects a link from a nib the video automatically cues to that moment. If the user wants to send the whole video, the user can simply click on the share button for the social network of the user's choice (see FIG. 5).

If the user desires to see more social icons, the user can click on a full screen button. Further, the user can click on the “Connect to Facebook” button to log in to FACEBOOK. FACEBOOK connect allows the user to post to his or her wall and see what his or her friends are doing on nibipedia. If a user is logged in, the user can add nibs using the search box near the share icons. On the display screen, the user may have access to the search results from several sources. For instance, the realm of available nibi's, or a particular nibi site coined the Nibisphere has nibs that are already used in other videos. Other tabs show search results from specific sources such as amazon books or wikipedia.

Thus, the disclosed software platform, nibipedia, is a platform neutral cross referencing synchronous collaborative learning/teaching social media environment that enables users to share deep-linked video assets with one another. More specifically, as a particular example of one embodiment, nibipedia is a platform, portal, site or application that allows or enables a user to watch videos with others in Facebook and share information from Wikipedia and Amazon like books, music or DVD's. Nibipedia also recommends videos that it heuristically concludes that a user may like and introduces the users to other users that have shown an inclination towards watching the same or similar videos.

As a specific example, a user may want to review information about the Large Hadron Collider. The user may enter the text “Large Hadron Collider” into the video search box and then select Brian Cox. Suppose the user then wonders who this Brian Cox fellow is. The user may then access and add a nib containing or linking to a bio of Brian Cox. When the user adds the nib to the video it automatically updates his FACEBOOK status.

As another example, suppose a user is checking out Brian's Wikipedia article and the user discovers the Brian Cox is not just a Royal Society research fellow, he was also in a 90's pop band. The user may find this very interesting in that someone that shares his interest is a real life Rock Star Physicist! So, the user may want to show this to his or her friends. The user can share the whole video by pressing the MYSPACE, TWITTER, FACEBOOK, etc. buttons on the share bar. But suppose the user just wants a particular friend to check out a particular passage 5 minutes into the video content. The user can add a nib to the particular point of interest in the timeline (this in essence creates a bookmark or placeholder, and then the user can drag the nib to the share button of his or her favorite social network. Now the user's friend doesn't have to watch the whole video as the nib includes all the necessary information to cue the user's friend to the particular location in the video and link to the supplemental content.

As yet another example, the various embodiments may direct a user to related topics that the user may find interesting and can also connect the user to people who like those topics as well.

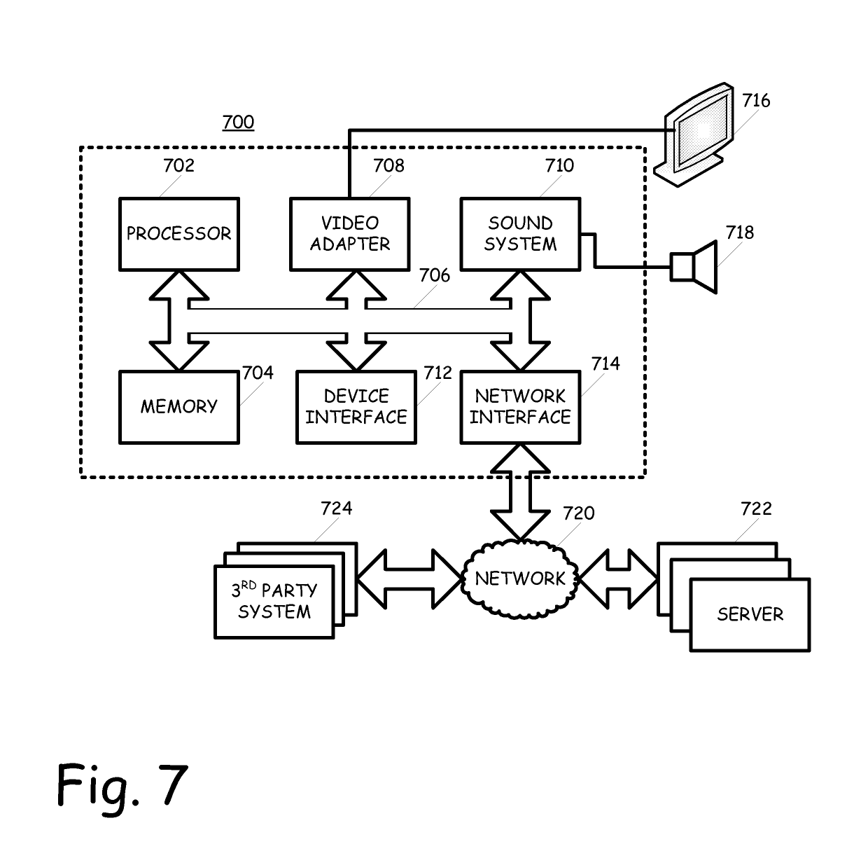

FIG. 7 is a general block diagram illustrating a hardware/system environment suitable for various embodiments of the synchronized media delivery system. A general computing platform 700 is shown as including a processor 702 that interfaces with a memory device 704 over a bus or similar interface 706. The processor 702 can be a variety of processor types including microprocessors, micro-controllers, programmable arrays, custom IC's etc. and may also include single or multiple processors with or without accelerators or the like. The memory element 704 may include a variety of structures, including but not limited to RAM, ROM, magnetic media, optical media, bubble memory, FLASH memory, EPROM, EEPROM, etc. The processor 702 also interfaces to a variety of elements including a video adapter 708, sound system 710, device interface 712 and network interface 714. The video adapter 708 is used to drive a display, monitor or dumb terminal 716. The sound system 710 interfaces to and drives a speaker or speaker system 718. The device interface 712 may interface to a variety of devices (not shown) such as a keyboard, a mouse, a pin pad, and audio activate device, a PS3 or other game controller, as well as a variety of the many other available input and output devices. The network interface 714 is used to interface the computing platform 700 to other devices through a network 720. The network may be a local network, a wide area network, a global network such as the Internet, or any of a variety of other configurations including hybrids, etc. The network interface may be a wired interface or a wireless interface. The computing platform 700 is shown as interfacing to a server 722 and a third party system 724 through the network 720.

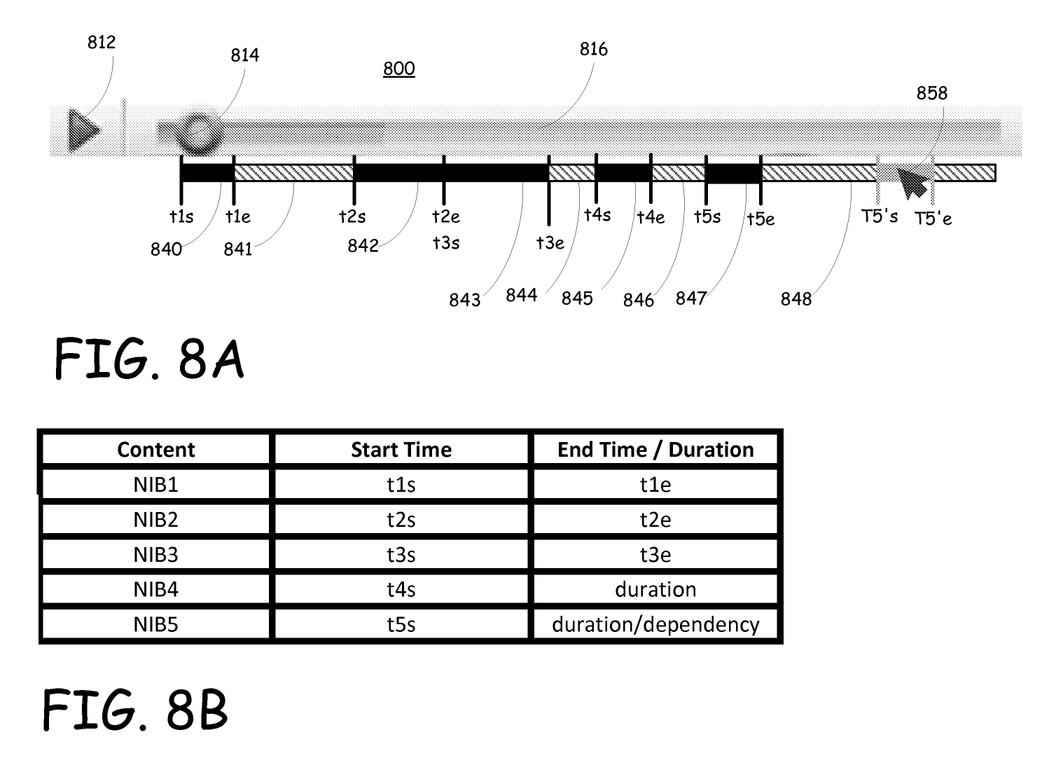

FIG. 8A is a schematic depiction of an alternate programming embodiment. In this embodiment, the user is able to program the presentation of the supplemental content through the use of a slider-bar system. A play/status bar 800 is illustrated with a status/actuator button 812 that shows the current status of the playback (i.e. playing, paused, stopped, etc) and that can be used to change states. The playback status 814 shows where in the playback the current cursor or timing is relative to the overall timeline 816. Below the play/status bar 800 a programming timeline is viewed. In the programming timeline, a series of segments are delineated by starting and stopping points. For instance, in the illustrated example, t1s and t1e illustrate the start time and the ending time for segment 840. In operation, supplemental content will be associated with this time segment 840. The supplemental content can be associated with the time segment 840 in any of the variety of manners previously described, as well as other techniques such as, but not limited to, (a) invoking a programming menu when the supplemental content is right clicked on, dragging and dropping an icon representative of the supplemental content onto the timeline, programming times into a programming interface such as illustrated in FIG. 8B, etc. Regardless of the technique used, each time segment includes a starting point and an ending point defining the duration of the time segment. The duration can be changed by selecting and dragging the starting point and or the ending point.

In the illustrated example, the timeline includes 9 time segments 840-848 with programmed time segments being in solid black (840, 842, 843, 845 and 847) and available time segments being represented in hash marks (841, 844, 846 and 848). For the time segment 840 defined by t1s and t1e, a user can modify the time segment 840 reserved for the content by selecting and dragging the point for t1e to the right to increase the time allocated for time segment 840 or, select and drag the entire segment to the right to change the relative position of the time segment with regards to the time line 816. As an example, looking at time segment 847 which is defined by starting point t5s and ending point t5e, a user can select and drag the time segment, either to the left or as illustrated, to the right, to change the relative position of the time segment. In the illustration, time segment 847 has been dragged to the right and is presently shown as a grayed out time segment 858. Once the user releases the selection button, the time segment 847 would be erased and the time segment 858 would become solid illustrating that the time segment has been successfully moved. As another example, time segment 842 is defined by the starting point t2s and the ending point t2e. The during of time segment 842 can be expanded by selecting and dragging the point t2s to the left to increase the duration or the right to decrease the duration. Similarly, the pint t2e can be selected and dragged to the left to decrease the duration or to the right to increase the duration. In this latter example, if the time segment 842 is modified by dragging point t2e to the right, it will have an impact on time segment 843. Depending on the various embodiments and options selected in the embodiments, the time segment 843 may be moved to accommodate the changes to time segment 842 or, the duration of time segment 843 may be modified to accommodate the changes to time segment 842.

FIG. 8B is a table diagram of an alternate programming embodiment. The table in FIG. 8B can be used in lieu of the slider interface illustrated in FIG. 8A or in addition to the slider interface. In the illustrated example, the table in FIG. 8B reflects the same time segment structure as illustrated in FIG. 8A. However, FIG. 8B shows some additional capabilities that can be incorporated into various embodiments. For example, the time slot defined for the content NIB4 is shown as being defined by a start time t4s and then a duration rather than a stop time. Advantageously this allows the user to more precisely control the time allocated to the content. Further, in reference to the time segment associated with the content NIB5, the time segment is defined as having a starting point t5s and then a duration as presented for the NIB4 time segment. However, in this case, a dependency is also presented indicating that the time segment is also dependent upon other time segment. As such, the time segment for NIB5 will only begin after the completion of any time segment from which it depends. For example, if the time segment for NIB5 is dependent upon the time segment for NIB4, and the duration of NIB4 is increased such that the ending time of the NIB4 time segment is greater than the time for t5s, then the time segment for NIB5 will automatically be adjusted to have a new t5s that starts upon the completion of the time segment for NIB4. In some embodiments, such an action may result in changing the overall duration of the time segment for NIB5 or, in other embodiments may have a fixed duration and thus only affect the ending time for the NIB5 time segment. The various embodiments may adopt various rules for making such determinations and applying heuristics to adjust the time segments. An example of some of the programming heuristics and capabilities can be seen in application such as MICROSOFT POWERPOINT.

Embodiments of the synchronized content delivery system have been described primarily in the context of the Internet and web applications. However, it will be appreciated that other venues may also provide a suitable environment. For instance, cable television and satellite television systems may employ various embodiments to present a variety of information. As a non-limiting example, the primary content may be the channel that is being viewed either as a live feed or as a playback from a digital video recorder. During the playback or the live feed, the timeline may be populated with items that are related to the primary content (i.e., the type of suit that Regis is wearing, a biography of a guest on the letterman show, and advertisement for a sponsor, etc. If the nib is selected, then a picture in picture window containing the information may pop up. Alternatively, the television display may temporarily switch over to display the content associated with the nib. In yet another embodiment, the television display may temporarily switch over to display the content associated with the nib and then revert back to the primary content after a predetermined period of time. In addition, in other embodiments the nibs may simply represent other channels and as the content of the primary feed is presented, the channels are scanned by enlarging and then shrinking nibs associated with other channels. If the nibi is selected, then a picture in picture PIP window can pop up with the content of the selected channel.

The synchronized content delivery system may also be employed in a system like ITUNES or ZUNE. For example, the primary content may be a video or audio file that is selected for playback. During the playback, nibs can be presented along with the progress bar and the nibs can expand as the progress bar advances. The nibs could be content related to the artist, the audio or video content, advertisements, etc. In addition, the embodiment may allow a user to build a slide show of nibs to be displayed during subsequent playback of the primary content. For instance, the user could assemble a show of selected photographs, videos and other items of interest, metadata or websites to be displayed while a song is playing in the back ground. Similar to the other embodiments, the user can then send the nibi to another user or, drag and drop a nib onto a destination icon to send a particular supplemental content to another user that would also invoke the playback of the associated audio content.

The synchronized content delivery system may be implemented on a variety of platforms including a computer, laptop, PDA, mobile telephone, IPHONE, ZUNE player, or any other electronic device with a suitable display.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method for presenting primary content and supplemental content in a time-line related scheme by a computing device having access to at least the source of the primary content and/or the supplemental content, the method comprising the steps of:
receiving a selection indicator from a client device, the selection indicator being associated with the invocation of a particular primary content item;
begin rendering the primary content on a user interface of the client device;
identifying a supplemental content item that is associated with a particular portion of the primary content item; and
render the supplemental content on the user interface device of the client device proximate to the particular portion of the primary content item.

2. The method of claim 1, wherein the step of receiving a selection indicator from a client device further comprises receiving a selection of a video file.

3. The method of claim 2, wherein the step of rendering the primary content on a user interface further comprises presenting the video content of the video file on a display and presenting the audio content of the video file to a speaker.

4. The method of claim 3, wherein the step of identifying a supplemental content item that is associated with a particular portion of the primary content item further comprises identifying a supplemental content item that has been associated with a particular point in time of the video file.

5. The method of claim 4, wherein the step of rendering the supplemental content on the user interface device further comprises the steps of:
displaying a progressive timeline bar associated with the video file;
rendering a thumbnail representative of the supplemental content at the location on the progressive timeline bar proximately associated with the particular point in time; and
as the playback of the video file approaches the particular point in time, activating the supplemental content.

6. The method of claim 5, wherein the step of activating the supplemental content further comprises the step of visibly modifying the thumbnail representing the supplemental content.

7. The method of claim 6, wherein the step of visibly modifying the thumbnail further comprises increasing the size of the thumbnail.

8. The method of claim 6, wherein the step of visibly modifying the thumbnail further comprises presenting the thumbnail in a Fibonacci spiral.

9. The method of claim 6, further comprising the steps of:
receiving an actuation of the active supplemental content;
retrieving the supplemental content; and
rendering the supplemental content on the user interface of the client device.

10. The method of claim 6, further comprising the steps of:
when the supplemental content becomes active, retrieving the supplemental content; and
rendering the supplemental content on the user interface of the client device.

11. A method for presenting primary content along with a series of supplemental content items, the method comprising the steps:
receiving a selection indicator from a client device, the selection indicator being associated with the invocation of a particular primary content item;
begin rendering the primary content on a user interface of the client device;
identifying a first supplemental content item that is associated with a first portion of the primary content item;
rendering the first supplemental content item on the user interface device of the client device along with the particular portion of the primary content item;
identifying a next supplemental content item that is associated with a next portion of the primary content item; and
rendering the next supplemental content item on the user interface device of the client device along with the next particular portion of the primary content item.

12. The method of claim 11, wherein the primary content is video content and the step of rendering the primary content further comprises beginning the playback of the video content.

13. The method of claim 11, wherein the primary content is video content and at least the first or next supplemental content item is primarily textual, and the step of rendering the primary content further comprises beginning the playback of the video content and, the step of identifying the first and next supplemental content item that is associated with a first and next portion of the primary content item further comprises a time-based association.

14. The method of claim 13, wherein the first or next supplement content item also includes graphic material, and the step of rendering the first and next supplemental content item further comprises displaying the text and graphics along with the associated portion of the primary content item.

15. The method of claim 13, further comprising the steps of:
displaying a timeline associated with the video content;
displaying a graphic element for each first and next supplemental content item along the timeline;
updating a cursor along the time line as the playback of the video content progresses; and
rendering the first and next supplemental content item when the cursor is proximate to the position of the first or next supplemental content item on the timeline.

16. The method of claim 15, wherein the step of rendering the first and next supplemental content item is only executed in response to a user actuation.

17. The method of claim 15, further comprising the steps of:
enhancing the appearance of the graphic element associated with a particular supplemental content item when the cursor is within a threshold distance from the position of the particular supplemental content item along the timeline; and.
deemphasizing the appearance of the graphic element associated with the particular supplement content item when the cursor has passed a threshold distance from the position of the particular content item along the timeline.

18. The method of claim 17, wherein the graphic element is a thumbnail sketch representing the associated supplemental content and the step of enhancing the appearance further comprises increasing the size of the thumbnail sketch and the step of deemphasizing the appearance further comprises decreasing the size of the thumbnail sketch.

19. A method for presenting video content along with a series of supplemental content items while rendering the video content on a user interface of a client device, the method comprising the steps:
monitoring the time progression of the video content;
identifying a supplemental content item that is associated with an approaching time slot of the video content;
providing an indicator representing that the supplemental content is available for viewing;
receiving an actuation associated with a request to view the supplemental content;
and
rendering the supplemental content on the user interface of the client device along with the video content.

20. The method of claim 19, further comprising the steps of:
receiving a user selection of an additional supplemental content item during the rendering of the video content; and
associating the additional supplemental content with a current time in the time progression of the video content.
